(19) United States
(12) Patent Application Publication
(10) Pub. No.: US 2004/0236562 A1
(43) Pub. Date: Nov. 25, 2004

(54) Using multiple simulation environments

(76) Inventor: Carl J. Beckmann, Newton, MA (US)

Correspondence Address: FISH & RICHARDSON, PC, 12390 EL CAMINO REAL, SAN DIEGO, CA, 92130-2081, US

(21) Appl. No.: 10/445,272

(22) Filed: May 23, 2003

(51) Int. Cl. G06F 9/45

(52) U.S. Cl. 703/22

(57) ABSTRACT

A first simulation environment for use in multiple simulation environments includes a first simulator application. The first simulator application includes a first simulator and a first graphical user interface (GUI). The first simulator environment also includes a first simulator plug-in that is configured to interface the first simulator application with a second simulation environment.

### BACKGROUND

Simulation tools may be helpful in developing, debugging, and/or optimizing a device before the device is built or otherwise available for actual use. A user may use a graphical user interface (GUI) provided by a simulation tool to generate an electronic simulation of a device and more easily test different scenarios using the device than could be achieved through testing of the actual device.

### DESCRIPTION OF THE DRAWINGS

FIG. 1 is a block diagram of a multiple simulation environment.

FIG. 2 is a flowchart of a process for sharing data from one simulator to another simulator in a multiple simulation environment.

FIG. 3 is a diagram of two threads in a multiple simulation environment.

FIG. 4 is a block diagram of a computer system on which the process of FIG. 2 may be implemented.

### DESCRIPTION

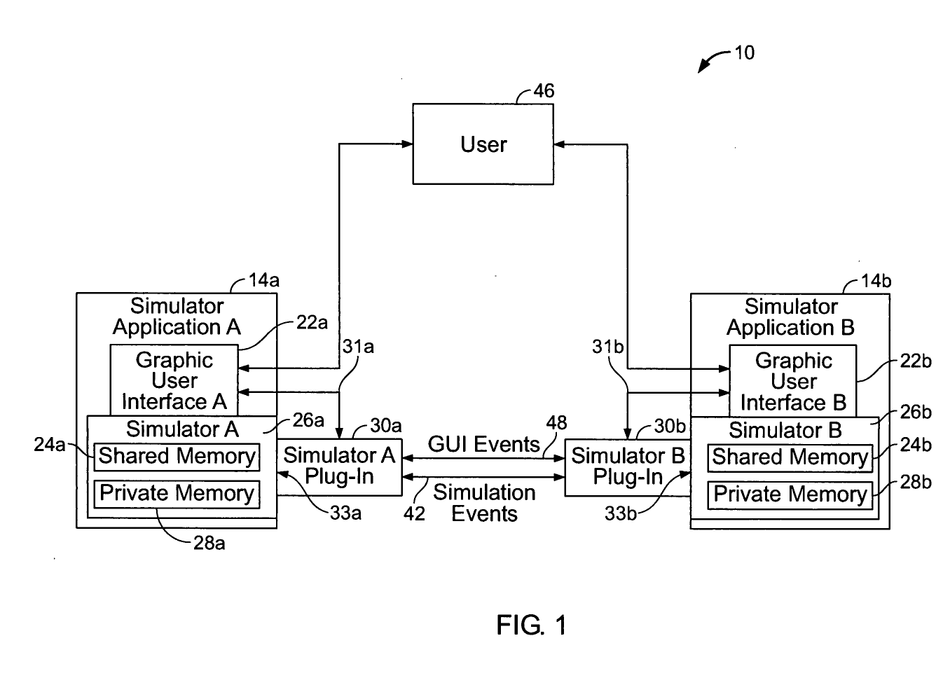

Referring to FIG. 1, a multiple simulation environment 10 includes multiple simulation applications (e.g., a simulator application 14a and a simulator application 14b). Each simulator application 14a and 14b includes a graphical user interface (GUI) (e.g., GUI 22a and GUI 22b) and a simulator (e.g., simulator 26a and simulator 26b). Each simulator 26a and 26b includes a shared memory (e.g., shared memory 24a and shared memory 24b) and a private or unshared memory (e.g., private memory 28a and private memory 28b). Each shared memory 24a and 24b is accessible by either simulator application 14a and 14b. Private memory 28a is not accessible by simulator application 14b and private memory 28b is not accessible by simulator application 14a.

A user 46 interfaces simulator 26a through GUI 22a and interfaces simulator 14b through GUI 22b. As will be described, changes affecting one simulator application can be reflected through the GUI and/or the simulator of the opposite simulator application. For example, changes to simulator application 14a can be reflected in GUI 22b and accounted for in simulator application 14b.

The multiple simulation environment 10 also includes simulator plug-ins (e.g., plug-in 30a and plug-in 30b). The plug-in can be, for example, a set of dynamic linked libraries (DLL), a shared object library, a static linked library and so forth. A plug-in generally is a program module of executable functions and/or data that can be used by an application (one or more programs). The plug-in typically provides one or more particular functions that the program may access through a static link and/or a dynamic link, for example. The static link remains constant during program execution while the program can generate the dynamic link as needed. The plug-in may be used by several applications at the same time.

In particular, simulator plug-in 30a interfaces with simulator plug-in 30b to exchange simulation events and GUI events. The simulator plug-ins 30a and 30b allow environment 10 to combine two simulator applications 14a and 14b. Environment 10 combines two different software simulators (e.g., simulator 26a and 26b) into a single unified simulator that preserves the GUIs 22a and 22b of each respective simulator application, while providing a combined behavioral simulation.

Each plug-in 30a and 30b interfaces the GUI 22a and 22b through an external application programmer interface (EAPI) (EAPI 31a and EAPI 31b). Each EAPI 31a and 33b is provided by the respective simulator application 14a and 14b. EAPIs 31a and 31b allow external applications and device plug-ins to extend the GUI 22a and 22b and to externally control the application 14a and 14b and its respective simulator 26a and 26b.

Each plug-in 30a and 30b also interfaces the simulator 26a and 26b through an application programmer interface (API) (API 33a and API 33b). APIs 33a and 33b allow their respective plug-ins 30a and 30b to access memory read and write events in their respective simulator 26a and 26b.

In environment 10, simulators 26a and 26b can include functionally accurate simulators, cycle accurate simulators and/or other type simulators. Further, the simulators may not be the same type. For example, one of the simulators 26a can be a functionally accurate simulator while the other simulator 26b can be a cycle accurate simulator.

Each simulator plug-in 30a and 30b extends the functionality of their respective simulator 26a and 26b in a number of ways. For example, each simulator plug-in 30a and 30b is connected to an interface 42 that allows the simulator plug-in 30a and 30b of its respective simulator 26a and 26b to communicate simulation events with the other one of simulator 26b and 26a, in order to provide a functional simulation of a complex system. In one example, interface 42 is a socket connection.

In another example, each simulator plug-in 30a and 30b is connected by an interface 48 that links GUIs 22a and 22b, so that the two GUIs synchronize GUI events, such as the user running, stopping, single-stepping, or resetting a simulation. Interface 48, for example, is a socket connection.

Each simulator plug-in 30a and 30b stores memory references from their respective simulator application 14a and 14b to a shared memory 24a and 24b and/or to their respective private memory 28a and 28b as determined by each simulator 26a and 26b. The simulator plug-in 30a and 30b also receives interrupt events from the other simulator 26b and 26a, which is passed on to simulator 26a and 26b.

In addition, each simulator plug-in 30a and 30b provides a bi-directional communications interface for user-level events such as starting and stopping a simulation, and other mode changes that both GUIs 22a and 22b are required to receive to properly account for the changes in the other simulator applications. Each simulator plug-in 30a and 30b also provides a capability for the GUI 22a and GUI 22b to start-up both simulator applications 14a and 14b and to establish a communications channel between the simulator applications 14a and 14b. Each simulator plug-in also provides the necessary GUI controls and functions to the simulator application to provide an interface to the GUI.

Each simulator plug-in 30a and 30b includes “callback” routines that are invoked from their respective GUI 22a and 22b and/or simulator 26a and 26b. The callback routines include an initialization routine, a simulation callback routine, and a GUI callback routine. In addition each plug-in 30a and 30b includes a GUI event receive thread that is used to receive and to handle GUI events; and a simulation event receive thread that is used to receive and to handle simulation events.

The initialization routine initializes all internal data structures, and starts up the GUI event receive thread. The GUI event receive thread searches for events generated by the other simulator applications and upon receiving an event, the GUI event receive thread makes an appropriate call to inform the respective simulator application 14a and 14b of a status change in the other simulator application's simulation. The initialization routine is invoked when plug-in 30a and 30b is loaded into a simulator application.

If a simulator application is started before the other simulator application is started, the initialization routine launches the other simulator application by passing appropriate command line arguments to the other simulator application to notify the other simulator application that a simulator application launched it. The initialization routine loads the other simulator application's respective plug-ins and establishes a connection for the simulation and GUI events.

The initialization routine also executes calls that generate, for example, control buttons and menu items on the GUI (not shown) for controlling the other simulator application from the simulator application (e.g., joint and individual Start, Stop and Reset control buttons, etc.), and for receiving callbacks from the respective GUI and simulator.

Each plug-in 30a and 30b provides simulation callback routines required by the respective simulation application to invoke the plug-ins during simulation. Some of these callback routines communicate with the other plug-ins by sending memory read and write requests.

The simulation event receives a thread that handles memory read and write requests from plug-ins on the simulation event interface 42. The simulation event results in a response being sent back to the plug-in with the result of the requested memory operation. If a bus access cycle is also being simulated, this thread synchronizes with the other simulator application, via locks or event synchronizations in the simulation callback routines, to simulate the indicated bus cycle before returning the response.

Each plug-in 30a and 30b provides a set of GUI callback routines used for receiving event notifications from their respective GUI 26a and 26b. GUI callback routines are used to receive Start, Stop, Reset, etc. events from the GUI 26a and 26b, in order to send event notifications to the other plug-in.

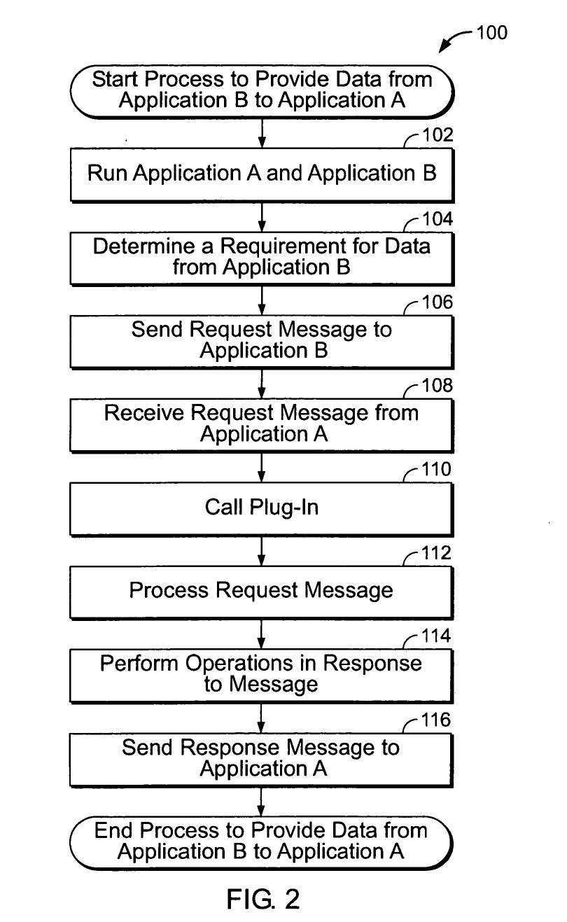

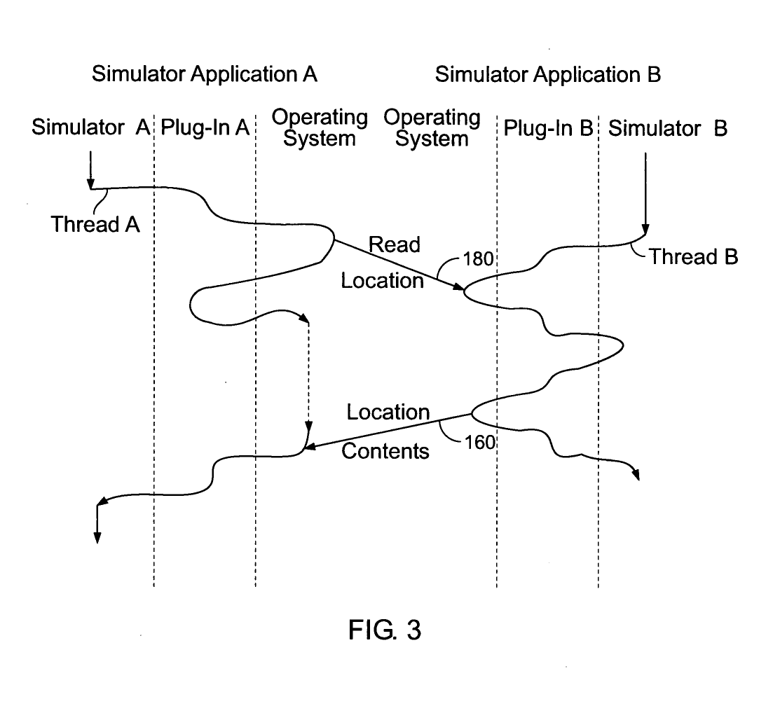

Referring to FIGS. 2 and 3, process 100 is an example of a simulated memory transfer, where a subsystem (not shown) simulated by simulator application 14a accesses data from another subsystem (not shown) simulated by simulator application 14b. Process 100 runs (102) simulator application 14a and simulator application 14b. Each simulation application runs an independent thread (e.g., thread A and thread B). Process 100 determines (104) that simulator application 14a requires data that resides within simulator application 14b, i.e., the required data is stored in shared memory 24b used by simulator application 14b. Process 100 sends (106) a request message 150, (e.g., a memory read) to simulator application 14b from simulator application 14a requesting the required data. Process 100 receives (108), at thread B, the request message 150 from simulator application 14a. Process 100 calls (110) plug-in 30b to perform a callback routine to check a message queue that includes the request message 150. Process 100 processes (112) the request message 150 sent from simulator application 14a. Process 100 performs (114) operations in response to the requested message 150 (i.e., plug-in 30b calls a function to read a value from memory). Process 100 sends (118) a return message 160 to the thread A that includes the required data (e.g., a value) by sending the return message from plug-in 30b through plug-in 30a.

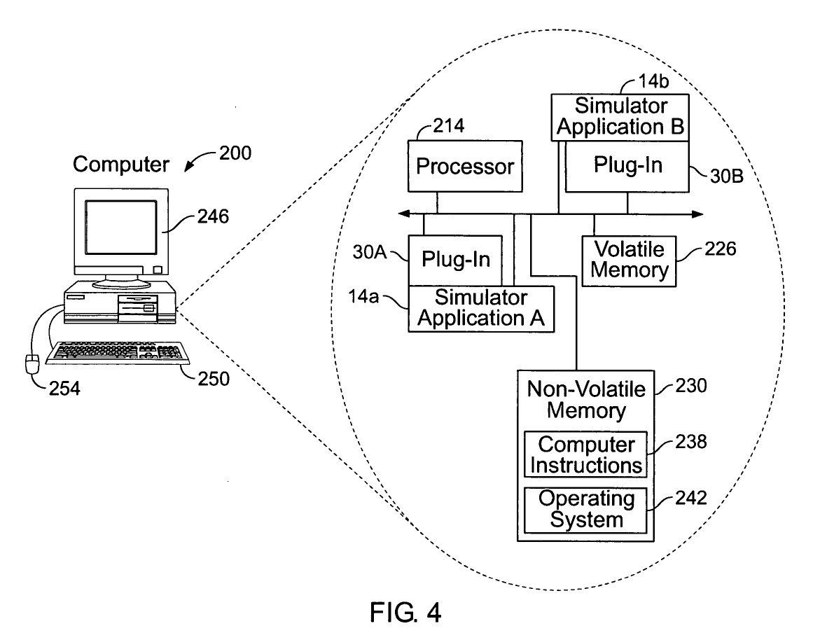

Referring to FIG. 4, a computer system 200 includes a processor 214, a volatile memory 226 (e.g., random access memory), a non-volatile memory 230 (e.g., hard disk), simulator application 14a and simulator application 14b. Non-volatile memory 230 stores operating system 242 and computer instructions 238 which are executed by processor 214 out of volatile memory 226 to perform a process 100. The user interfaces with each simulator application 14a and 14b through a keyboard 250 or a mouse 254. The user observes the simulator applications on monitor 246.

Process 100 is not limited to use with the hardware and software of FIG. 4; they may find applicability in any computing or processing environment and with any type of machine that is capable of running a computer program. Process 100 may be implemented in hardware, software, or a combination of the two. For example, process 100 may be implemented in a circuit that includes one or a combination of a processor, a memory, programmable logic and logic gates. Process 100 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 100 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 100. Process 100 may also be implemented as one or more machine-readable storage media, configured with a computer program(s), where upon execution, instructions in the computer program(s) cause a computer to operate in accordance with process 100.

Process 100 is not limited to the specific embodiments described herein. Process 100 is not limited to the specific processing order of FIG. 2. Rather, the blocks of FIG. 2 may be re-ordered, as necessary, to achieve the results set forth above.

Other embodiments not described herein are also within the scope of the following claims.

What is claimed is:

1. A first simulation environment for use in multiple simulation environments, comprising:
a first simulator application including a first simulator and a first graphical user interface (GUI); and
a first simulator plug-in configured to interface the first simulator application with a second simulation environment.

2. The first simulation environment of claim 1, wherein the second simulation environment comprises a second simulator plug-in and a second simulator application comprising a second simulator and a second GUI; and
wherein the first simulator plug-in is configured to interface with the second plug-in.

3. The first simulation environment of claim 1, wherein configured to interface comprises being configured to provide data from the first GUI and the first simulator to a second simulator application and being configured to receive data from the second simulator application.

4. The first simulation environment of claim 1, wherein the first simulator comprises a cycle accurate simulator.

5. The first simulation environment of claim 4, wherein the second simulation application comprises a functionally accurate simulator.

6. The first simulation environment of claim 1, wherein the first plug-in sends a message to a second simulation application via the second plug-in to perform a requested operation using a first thread; and
wherein the second simulator application receives the message in a second thread and performs the requested operation using the second thread.

7. The first simulation environment of claim 6, wherein the message is a first message; and
wherein the second plug-in returns a result of the requested operation to the first simulation environment using a second message.

8. The first simulation environment of claim 7, wherein the first thread and the second thread are independent threads.

9. The first simulation environment of claim 1, wherein the second simulator comprises a shared memory that is accessible by the first simulator environment.

10. The first simulation environment of claim 9, wherein the first simulation environment manages the shared memory.

11. A method comprising:
retrieving data from a first simulation environment; and
providing the data to a second simulation environment.

12. The method of claim 11 wherein the data comprises graphical user interface (GUI) events; and
providing the data comprises providing GUI events from the first simulation environment to a graphical user interface in the second simulation environment.

13. The method of claim 11 wherein the data comprises simulation events; and
providing the data comprises providing simulation events from the first simulation environment to a simulator in the second simulation environment.

14. The method of claim 11, further comprising:
retrieving additional data from the second simulation environment; and
providing the additional data to a first simulation environment;
wherein the additional data comprises simulation events and graphical user interface (GUI) events.

15. The method of claim 11 wherein the first simulation environment comprises a cycle accurate simulator.

16. The method of claim 15 wherein the second environment comprises a functionally accurate simulator.

17. The method of claim 11 wherein retrieving the data comprises:
sending a message to the first simulation environment to perform a requested operation using a first thread;
receiving the message in a second thread; and
performing the requested operation using the second thread.

18. The method of claim 17 wherein the message is a first message and providing the data comprises:
returning a result of the requested operation to the second simulator environment using a second message;
wherein the first thread and the second thread are independent threads.

19. The method of claim 11, further comprising:
providing a shared memory that is accessible by the first simulation environment and the second simulation environment;
wherein one simulation environment manages the shared memory.

20. An article comprising a machine-readable medium that stores executable instructions for use in multiple simulation environments, the instructions causing a machine to:
retrieve data from a first simulation environment; and
provide the data to a second simulation environment.

21. The article of claim 20 wherein the data comprises graphical user interface (GUI) events; and
the instructions causing a machine to provide data comprises providing GUI events from the first simulation environment to a GUI in the second simulation environment.

22. The article of claim 20 wherein the data comprises simulation events; and
the instructions causing a machine to provide data comprises providing simulation events from the first simulation environment to a simulator in the second simulation environment.

23. The article of claim 20, further comprising instructions causing a machine to:
retrieve additional data from the second simulation environment; and
provide the additional data to a first simulation environment;
wherein the additional data comprises simulation events and graphical user interface (GUI) events.

24. The article of claim 20 wherein the first simulation environment comprises a cycle accurate simulator and the second environment comprises a functionally accurate simulator.

25. The article of claim 20 wherein the instructions causing a machine to retrieve the data comprises:
sending a message to the first simulation environment to perform a requested operation using a first thread;
receiving the message in a second thread; and
performing the requested operation using the second thread.

26. The article of claim 25 wherein the message is a first message and the instructions causing a machine to provide data comprises:
returning a result of the requested operation to the second simulator environment using a second message;
wherein the first thread and the second thread are independent threads.

27. The article of claim 20, further comprising instructions causing a machine to:
provide a shared memory that is accessible by the first simulation environment and the second simulation environment;
wherein one simulation environment manages the shared memory.

28. A system, comprising:
a first simulation environment;
a second simulation environment;
a first simulator plug-in interfacing the first simulation environment with a second simulator plug-in interfacing a second simulation environment;
wherein the first simulator plug-in retrieves data from the second simulation environment for use with the first simulation environment and the second simulator plug-in retrieves data from the first simulator plug-in for use with the second simulation environment.

29. The system of claim 28, wherein data comprises simulation events.

30. The system of claim 28, wherein data comprises GUI events.
